(19) United States
(12) Patent Application Publication
(10) Pub. No.: US 2026/0017589 A1
(43) Pub. Date: Jan. 15, 2026

(54) Learning Techniques for Causal Discovery

(71) Applicant: ServiceNow, Inc., Santa Clara, CA (US)

(72) Inventors: Dinesh Kumar Kishorkumar Surapaneni, Chicago, IL (US); Alexandre Drouin, Montreal (CA); Deepak Venkatanarasimhan, Toronto (CA); Sumana Ravikrishnan, Hyderabad (IN)

(21) Appl. No.: 18/659,524

(22) Filed: May 9, 2024

Related U.S. Application Data
(60) Provisional application No. 63/465,320, filed on May 10, 2023.

(51) Int. Cl. G06Q 10/0633; G06N 5/022; G06Q 10/0637; G06Q 10/067

(52) U.S. Cl. CPC G06Q 10/0633; G06N 5/022; G06Q 10/06375; G06Q 10/0674

(57) ABSTRACT

An example embodiment may involve: obtaining static data from work items of a process and dynamic data from event logs of the process; generating, from the static data and the dynamic data, a causal graph of dependencies between features of the process; providing, to a natural language model, representations of the causal graph and the dependencies; and obtaining, from the natural language model, indications of an inefficiency in the process.

### CROSS-REFERENCE TO RELATED APPLICATION

This application claims priority to U.S. provisional patent application No. 63/465,320, filed May 10, 2023, which is hereby incorporated by reference in its entirety.

### BACKGROUND

Workflow and process-related data can be collected by storing work item information in a database and logging events that took place during the performance of a process on work items. The combination of this data can be used to generate representations of how work items flow through the process. However, determining the actual operations of the process from this data is complicated as the results are difficult to interpret. As a consequence, process inefficiencies often remain unaddressed, leading to significantly wastage in memory, storage, and processing resources of computing systems.

### SUMMARY

The embodiments herein overcome various limitations of other techniques by way of a specific set of procedures that can be used to provide actionable process improvements in an easy-to-understand fashion. Initially, both static and dynamic process data may be collected for a given process. This process data can be used to generate a set of features that characterize operation of the process. Constraints are applied to these features to derive a graph that depicts causality between the features. A structured learning technique may be used to generate the graph as well as conditional probabilities between subsets of the features. Then, these conditional probabilities can be provided to a natural language processing model to provide a prompt-based and/or query-based interface for determining actionable recommendations. In some cases, the conditional probabilities or the actionable recommendations may be automatically implemented by a machine changing the state of the software and/or hardware of computing systems that perform the process.

Accordingly, a first example embodiment may involve obtaining static data from work items of a process and dynamic data from event logs of the process; generating, from the static data and the dynamic data, a causal graph of dependencies between features of the process; providing, to a natural language model, representations of the causal graph and the dependencies; and obtaining, from the natural language model, indications of an inefficiency in the process.

A second example embodiment may involve a non-transitory computer-readable medium, having stored thereon program instructions that, upon execution by a computing system, cause the computing system to perform operations in accordance with any previous example embodiment.

In a third example embodiment, a computing system may include at least one processor, as well as memory and program instructions. The program instructions may be stored in the memory, and upon execution by the at least one processor, cause the computing system to perform operations in accordance with any previous example embodiment.

In a fourth example embodiment, a system may include various means for carrying out each of the operations of any previous example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5 depicts another communication environment involving a remote network management architecture, in accordance with example embodiments.

FIG. 6 depicts a flow of work items through a process, in accordance with example embodiments.

FIG. 7 depicts a three-part procedure for generating a representation of the operation of a process, in accordance with example embodiments.

FIG. 8A depicts methods for feature generation based on static data, in accordance with example embodiments.

FIG. 8B depicts methods for feature generation based on dynamic data, in accordance with example embodiments.

FIG. 9A depicts a structure learning process, in accordance with example embodiments.

FIG. 9B depicts constraints on structure learning, in accordance with example embodiments.

FIG. 9C depicts a causal graph, in accordance with example embodiments.

FIG. 9D depicts conditional probabilities of time to resolution for various combinations of feature values, in accordance with example embodiments.

FIGS. 10A and 10B depict using a causal graph with inference methods to develop actionable insights, in accordance with example embodiments.

FIG. 10C depicts a prompt for a large language model (LLM), in accordance with example embodiments.

FIGS. 11A, 11B, 11C, and 11D provide a summary of insight and recommendation generation from process data using causal graphs, in accordance with example embodiments.

FIG. 12 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. EXAMPLE TECHNICAL IMPROVEMENTS

These embodiments provide a technical solution to a technical problem. One technical problem being solved is more efficient usage of computing resources relating to processes (e.g., workflows followed by human users and/or software applications). In practice, this is problematic because such processes are frequently employed in computing platforms and often suffer from inefficiencies in the form of cycles, delays, and incorrect outcomes.

In the prior art, it was virtually impossible to discover the root causes of process inefficiency, as these processes are complex and causal relationships between process activity and behavior of hardware and software components are often indirect. Moreover, the prior art relied on subjective decisions and experiences of administrators, which led to wildly varying outcomes from instance to instance. Thus, prior art techniques did little if anything to address process inefficiency.

The embodiments herein overcome these limitations by employing a structured learning algorithm to generate a causal graph from static feature data, dynamic feature data, and various constraints. Based on the causal graph, a natural language model, such as a large language model, can be used to generate observations and recommendations for process improvement. In this manner, reduction of process inefficiencies can be accomplished in a more accurate and robust fashion. This results in several advantages. First, fewer computing resources (e.g., processing power and memory) are used as there are less cyclic traversals of processes. Second, process inefficiencies can be clearly identified based on actual evidence and causality rather than guesswork. Third, overall application utility, usability, and correctness are increased as work items are directed more accurately through processes.

Other technical improvements may also flow from these embodiments, and other technical problems may be solved. Thus, this statement of technical improvements is not limiting and instead constitutes examples of advantages that can be realized from the embodiments.

### II. INTRODUCTION

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM) and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) is introduced, to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security. Nonetheless, the embodiments herein are not limited to enterprise applications or environments, and can be more broadly applied.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure. In some cases, applications structured differently than MVC, such as those using unidirectional data flow, may be employed.

The aPaaS system may support standardized application components, such as a standardized set of widgets for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HyperText Markup Language (HTML) and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### III. EXAMPLE COMPUTING DEVICES AND CLOUD-BASED COMPUTING ENVIRONMENTS

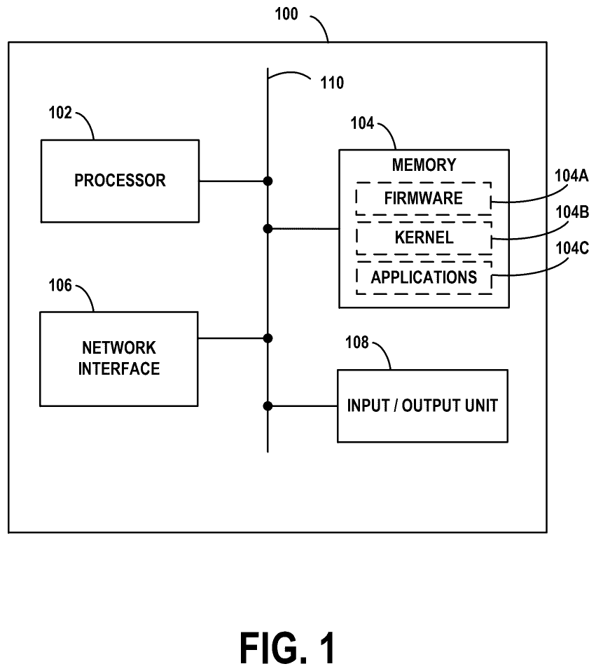

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a co-processor (e.g., a mathematics, graphics, or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Other types of memory may include biological memory.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, and so on). Network interface 106 may also support communication over one or more non-Ethernet media, such as coaxial cables or power lines, or over wide-area media, such as Synchronous Optical Networking (SONET) or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed to support an aPaaS architecture. The exact physical location, connectivity, and configuration of these computing devices may be unknown and/or unimportant to client devices. Accordingly, the computing devices may be referred to as “cloud-based” devices that may be housed at various remote data center locations.

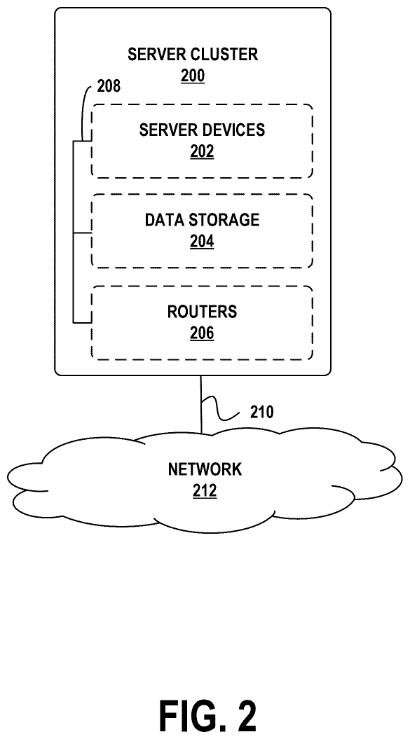

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database. Various types of data structures may store the information in such a database, including but not limited to tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as HTML, the eXtensible Markup Language (XML), or some other standardized or proprietary format. Moreover, server devices 202 may have the capability of executing various types of computerized scripting languages, such as but not limited to Perl, Python, PUP Hypertext Preprocessor (PUP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### IV. EXAMPLE REMOTE NETWORK MANAGEMENT ARCHITECTURE

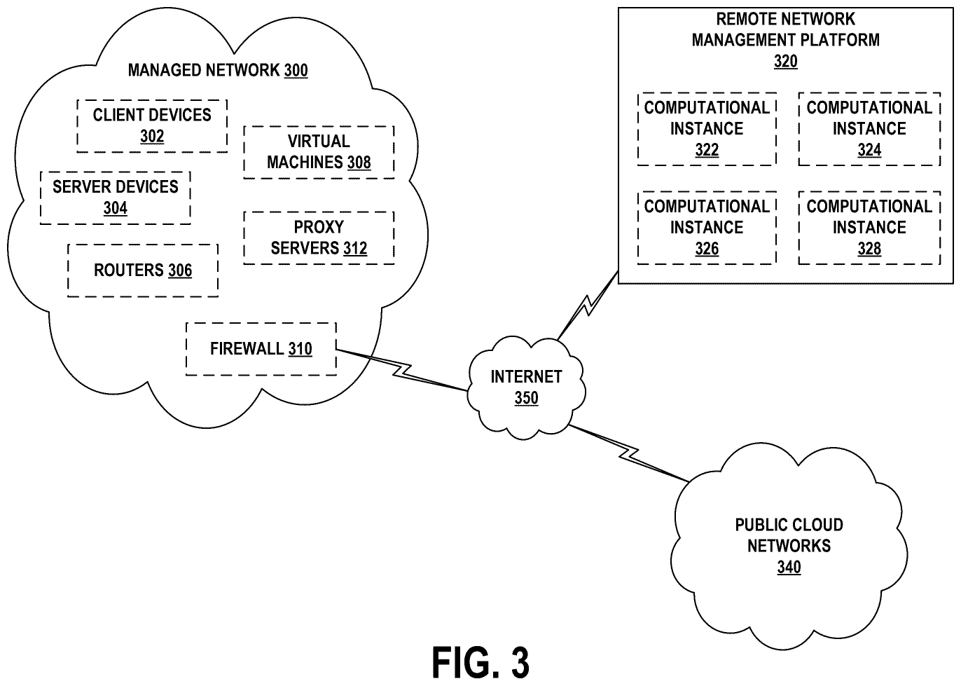

FIG. 3 depicts a remote network management architecture, in accordance with example embodiments. This architecture includes three main components—managed network 300, remote network management platform 320, and public cloud networks 340—all connected by way of Internet 350.

### A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components.

Possibly with the assistance of proxy servers 312, remote network management platform 320 may also be able to discover and manage aspects of public cloud networks 340 that are used by managed network 300. While not shown in FIG. 3, one or more proxy servers 312 may be placed in any of public cloud networks 340 in order to facilitate this discovery and management.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

### B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks. Remote network management platform 320 may also be referred to as a multi-application platform.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may affect all customers' data, creating additional risk, especially for entities subject to governmental, healthcare, and/or financial regulation. Furthermore, any database operations that affect one customer will likely affect all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

### C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include Amazon AWS Cloud, Microsoft Azure Cloud (Azure), Google Cloud Platform (GCP), and IBM Cloud Platform. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

### D. Communication Support and Other Operations

Internet 350 may represent a portion of the global Internet. However, Internet 350 may alternatively represent a different type of network, such as a private wide-area or local-area packet-switched network.

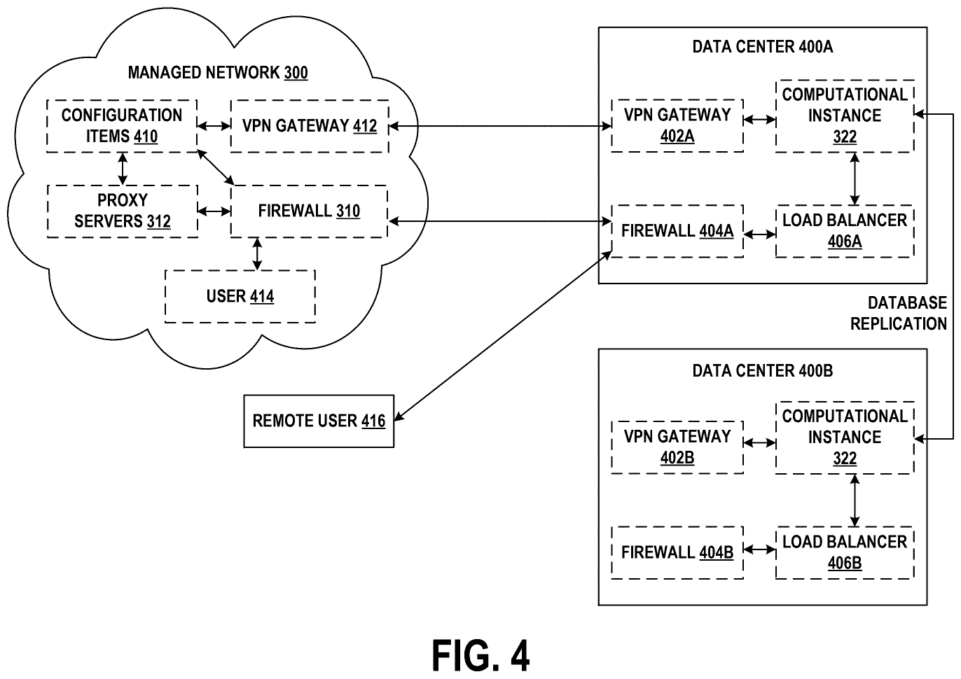

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any components thereof, any applications or services executing thereon, as well as relationships between devices, components, applications, and services. Thus, the term “configuration items” may be shorthand for part of all of any physical or virtual device, or any application or service remotely discoverable or managed by computational instance 322, or relationships between discovered devices, applications, and services. Configuration items may be represented in a configuration management database (CMDB) of computational instance 322.

As stored or transmitted, a configuration item may be a list of attributes that characterize the hardware or software that the configuration item represents. These attributes may include manufacturer, vendor, location, owner, unique identifier, description, network address, operational status, serial number, time of last update, and so on. The class of a configuration item may determine which subset of attributes are present for the configuration item (e.g., software and hardware configuration items may have different lists of attributes).

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively). In various alternatives, devices in managed network 300, such as proxy servers 312, may use a secure protocol (e.g., TLS) to communicate directly with one or more data centers.

### V. EXAMPLE DISCOVERY

In order for remote network management platform 320 to administer the devices, applications, and services of managed network 300, remote network management platform 320 may first determine what devices are present in managed network 300, the configurations, constituent components, and operational statuses of these devices, and the applications and services provided by the devices. Remote network management platform 320 may also determine the relationships between discovered devices, their components, applications, and services. Representations of each device, component, application, and service may be referred to as a configuration item. The process of determining the configuration items and relationships within managed network 300 is referred to as discovery, and may be facilitated at least in part by proxy servers 312. Representations of configuration items and relationships are stored in a CMDB.

While this section describes discovery conducted on managed network 300, the same or similar discovery procedures may be used on public cloud networks 340. Thus, in some environments, “discovery” may refer to discovering configuration items and relationships on a managed network and/or one or more public cloud networks.

For purposes of the embodiments herein, an “application” may refer to one or more processes, threads, programs, client software modules, server software modules, or any other software that executes on a device or group of devices. A “service” may refer to a high-level capability provided by one or more applications executing on one or more devices working in conjunction with one another. For example, a web service may involve multiple web application server threads executing on one device and accessing information from a database application that executes on another device.

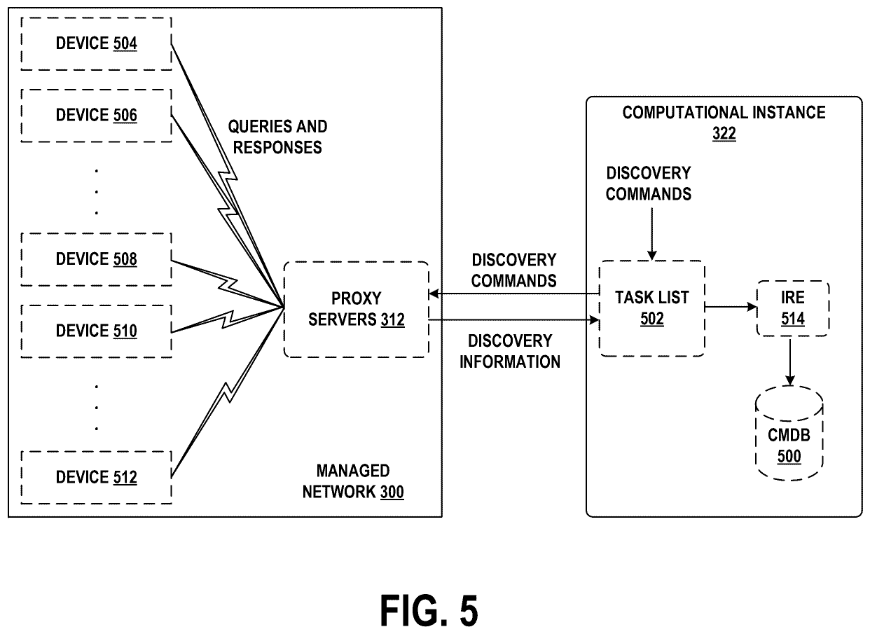

FIG. 5 provides a logical depiction of how configuration items and relationships can be discovered, as well as how information related thereto can be stored. For sake of simplicity, remote network management platform 320, public cloud networks 340, and Internet 350 are not shown.

In FIG. 5, CMDB 500, task list 502, and identification and reconciliation engine (IRE) 514 are disposed and/or operate within computational instance 322. Task list 502 represents a connection point between computational instance 322 and proxy servers 312. Task list 502 may be referred to as a queue, or more particularly as an external communication channel (ECC) queue. Task list 502 may represent not only the queue itself but any associated processing, such as adding, removing, and/or manipulating information in the queue.

As discovery takes place, computational instance 322 may store discovery tasks (jobs) that proxy servers 312 are to perform in task list 502, until proxy servers 312 request these tasks in batches of one or more. Placing the tasks in task list 502 may trigger or otherwise cause proxy servers 312 to begin their discovery operations. For example, proxy servers 312 may poll task list 502 periodically or from time to time, or may be notified of discovery commands in task list 502 in some other fashion. Alternatively or additionally, discovery may be manually triggered or automatically triggered based on triggering events (e.g., discovery may automatically begin once per day at a particular time).

Regardless, computational instance 322 may transmit these discovery commands to proxy servers 312 upon request. For example, proxy servers 312 may repeatedly query task list 502, obtain the next task therein, and perform this task until task list 502 is empty or another stopping condition has been reached. In response to receiving a discovery command, proxy servers 312 may query various devices, components, applications, and/or services in managed network 300 (represented for sake of simplicity in FIG. 5 by devices 504, 506, 508, 510, and 512). These devices, components, applications, and/or services may provide responses relating to their configuration, operation, and/or status to proxy servers 312. In turn, proxy servers 312 may then provide this discovered information to task list 502 (i.e., task list 502 may have an outgoing queue for holding discovery commands until requested by proxy servers 312 as well as an incoming queue for holding the discovery information until it is read).

IRE 514 may be a software module that removes discovery information from task list 502 and formulates this discovery information into configuration items (e.g., representing devices, components, applications, and/or services discovered on managed network 300) as well as relationships therebetween. Then, IRE 514 may provide these configuration items and relationships to CMDB 500 for storage therein. The operation of IRE 514 is described in more detail below.

In this fashion, configuration items stored in CMDB 500 represent the environment of managed network 300. As an example, these configuration items may represent a set of physical and/or virtual devices (e.g., client devices, server devices, routers, or virtual machines), applications executing thereon (e.g., web servers, email servers, databases, or storage arrays), as well as services that involve multiple individual configuration items. Relationships may be pairwise definitions of arrangements or dependencies between configuration items.

In order for discovery to take place in the manner described above, proxy servers 312, CMDB 500, and/or one or more credential stores may be configured with credentials for the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

There are two general types of discovery—horizontal and vertical (top-down). Each are discussed below.

### A. Horizontal Discovery

Horizontal discovery is used to scan managed network 300, find devices, components, and/or applications, and then populate CMDB 500 with configuration items representing these devices, components, and/or applications. Horizontal discovery also creates relationships between the configuration items. For instance, this could be a “runs on” relationship between a configuration item representing a software application and a configuration item representing a server device on which it executes. Typically, horizontal discovery is not aware of services and does not create relationships between configuration items based on the services in which they operate.

There are two versions of horizontal discovery. One relies on probes and sensors, while the other also employs patterns. Probes and sensors may be scripts (e.g., written in JAVASCRIPT®) that collect and process discovery information on a device and then update CMDB 500 accordingly. More specifically, probes explore or investigate devices on managed network 300, and sensors parse the discovery information returned from the probes.

Patterns are also scripts that collect data on one or more devices, process it, and update the CMDB. Patterns differ from probes and sensors in that they are written in a specific discovery programming language and are used to conduct detailed discovery procedures on specific devices, components, and/or applications that often cannot be reliably discovered (or discovered at all) by more general probes and sensors. Particularly, patterns may specify a series of operations that define how to discover a particular arrangement of devices, components, and/or applications, what credentials to use, and which CMDB tables to populate with configuration items resulting from this discovery.

Both versions may proceed in four logical phases: scanning, classification, identification, and exploration. Also, both versions may require specification of one or more ranges of IP addresses on managed network 300 for which discovery is to take place. Each phase may involve communication between devices on managed network 300 and proxy servers 312, as well as between proxy servers 312 and task list 502. Some phases may involve storing partial or preliminary configuration items in CMDB 500, which may be updated in a later phase.

In the scanning phase, proxy servers 312 may probe each IP address in the specified range(s) of IP addresses for open Transmission Control Protocol (TCP) and/or User Datagram Protocol (UDP) ports to determine the general type of device and its operating system. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist.

In the classification phase, proxy servers 312 may further probe each discovered device to determine the type of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the specific type of operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 10, as a set of WINDOWS®-10-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500 along with any relevant relationships therebetween. Doing so may involve passing the identification information through IRE 514 to avoid generation of duplicate configuration items, for purposes of disambiguation, and/or to determine the table(s) of CMDB 500 in which the discovery information should be written.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (software applications), and so on. Once more, the discovered information may be stored as one or more configuration items in CMDB 500, as well as relationships.

Running horizontal discovery on certain devices, such as switches and routers, may utilize SNMP. Instead of or in addition to determining a list of running processes or other application-related information, discovery may determine additional subnets known to a router and the operational state of the router's network interfaces (e.g., active, inactive, queue length, number of packets dropped, etc.). The IP addresses of the additional subnets may be candidates for further discovery procedures. Thus, horizontal discovery may progress iteratively or recursively.

Patterns are used only during the identification and exploration phases—under pattern-based discovery, the scanning and classification phases operate as they would if probes and sensors are used. After the classification stage completes, a pattern probe is specified as a probe to use during identification. Then, the pattern probe and the pattern that it specifies are launched.

Patterns support a number of features, by way of the discovery programming language, that are not available or difficult to achieve with discovery using probes and sensors. For example, discovery of devices, components, and/or applications in public cloud networks, as well as configuration file tracking, is much simpler to achieve using pattern-based discovery. Further, these patterns are more easily customized by users than probes and sensors. Additionally, patterns are more focused on specific devices, components, and/or applications and therefore may execute faster than the more general approaches used by probes and sensors.

Once horizontal discovery completes, a configuration item representation of each discovered device, component, and/or application is available in CMDB 500. For example, after discovery, operating system version, hardware configuration, and network configuration details for client devices, server devices, and routers in managed network 300, as well as applications executing thereon, may be stored as configuration items. This collected information may be presented to a user in various ways to allow the user to view the hardware composition and operational status of devices.

Furthermore, CMDB 500 may include entries regarding the relationships between configuration items. More specifically, suppose that a server device includes a number of hardware components (e.g., processors, memory, network interfaces, storage, and file systems), and has several software applications installed or executing thereon. Relationships between the components and the server device (e.g., “contained by” relationships) and relationships between the software applications and the server device (e.g., “runs on” relationships) may be represented as such in CMDB 500.

More generally, the relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

In this manner, remote network management platform 320 may discover and inventory the hardware and software deployed on and provided by managed network 300.

### B. Vertical Discovery

Vertical discovery is a technique used to find and map configuration items that are part of an overall service, such as a web service. For example, vertical discovery can map a web service by showing the relationships between a web server application, a LINUX® server device, and a database that stores the data for the web service. Typically, horizontal discovery is run first to find configuration items and basic relationships therebetween, and then vertical discovery is run to establish the relationships between configuration items that make up a service.

Patterns can be used to discover certain types of services, as these patterns can be programmed to look for specific arrangements of hardware and software that fit a description of how the service is deployed. Alternatively or additionally, traffic analysis (e.g., examining network traffic between devices) can be used to facilitate vertical discovery. In some cases, the parameters of a service can be manually configured to assist vertical discovery.

In general, vertical discovery seeks to find specific types of relationships between devices, components, and/or applications. Some of these relationships may be inferred from configuration files. For example, the configuration file of a web server application can refer to the IP address and port number of a database on which it relies. Vertical discovery patterns can be programmed to look for such references and infer relationships therefrom. Relationships can also be inferred from traffic between devices—for instance, if there is a large extent of web traffic (e.g., TCP port 80 or 8080) traveling between a load balancer and a device hosting a web server, then the load balancer and the web server may have a relationship.

Relationships found by vertical discovery may take various forms. As an example, an email service may include an email server software configuration item and a database application software configuration item, each installed on different hardware device configuration items. The email service may have a “depends on” relationship with both of these software configuration items, while the software configuration items have a “used by” reciprocal relationship with the email service. Such services might not be able to be fully determined by horizontal discovery procedures, and instead may rely on vertical discovery and possibly some extent of manual configuration.

### C. Advantages of Discovery

Regardless of how discovery information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

In another example, suppose that a database application is executing on a server device, and that this database application is used by an employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular hardware device fails.

In general, configuration items and/or relationships between configuration items may be displayed on a web-based interface and represented in a hierarchical fashion. Modifications to such configuration items and/or relationships in the CMDB may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

### VI. CMDB IDENTIFICATION RULES AND RECONCILIATION

A CMDB, such as CMDB 500, provides a repository of configuration items and relationships. When properly provisioned, it can take on a key role in higher-layer applications deployed within or involving a computational instance. These applications may relate to enterprise IT service management, operations management, asset management, configuration management, compliance, and so on.

For example, an IT service management application may use information in the CMDB to determine applications and services that may be impacted by a component (e.g., a server device) that has malfunctioned, crashed, or is heavily loaded. Likewise, an asset management application may use information in the CMDB to determine which hardware and/or software components are being used to support particular enterprise applications. As a consequence of the importance of the CMDB, it is desirable for the information stored therein to be accurate, consistent, and up to date.

A CMDB may be populated in various ways. As discussed above, a discovery procedure may automatically store information including configuration items and relationships in the CMDB. However, a CMDB can also be populated, as a whole or in part, by manual entry, configuration files, and third-party data sources. Given that multiple data sources may be able to update the CMDB at any time, it is possible that one data source may overwrite entries of another data source. Also, two data sources may each create slightly different entries for the same configuration item, resulting in a CMDB containing duplicate data. When either of these occurrences takes place, they can cause the health and utility of the CMDB to be reduced.

In order to mitigate this situation, these data sources might not write configuration items directly to the CMDB. Instead, they may write to an identification and reconciliation application programming interface (API) of RE 514. Then, IRE 514 may use a set of configurable identification rules to uniquely identify configuration items and determine whether and how they are to be written to the CMDB.

In general, an identification rule specifies a set of configuration item attributes that can be used for this unique identification. Identification rules may also have priorities so that rules with higher priorities are considered before rules with lower priorities. Additionally, a rule may be independent, in that the rule identifies configuration items independently of other configuration items. Alternatively, the rule may be dependent, in that the rule first uses a metadata rule to identify a dependent configuration item.

Metadata rules describe which other configuration items are contained within a particular configuration item, or the host on which a particular configuration item is deployed. For example, a network directory service configuration item may contain a domain controller configuration item, while a web server application configuration item may be hosted on a server device configuration item.

A goal of each identification rule is to use a combination of attributes that can unambiguously distinguish a configuration item from all other configuration items, and is expected not to change during the lifetime of the configuration item. Some possible attributes for an example server device may include serial number, location, operating system, operating system version, memory capacity, and so on. If a rule specifies attributes that do not uniquely identify the configuration item, then multiple components may be represented as the same configuration item in the CMDB. Also, if a rule specifies attributes that change for a particular configuration item, duplicate configuration items may be created.

Thus, when a data source provides information regarding a configuration item to IRE 514, IRE 514 may attempt to match the information with one or more rules. If a match is found, the configuration item is written to the CMDB or updated if it already exists within the CMDB. If a match is not found, the configuration item may be held for further analysis.

Configuration item reconciliation procedures may be used to ensure that only authoritative data sources are allowed to overwrite configuration item data in the CMDB. This reconciliation may also be rules-based. For instance, a reconciliation rule may specify that a particular data source is authoritative for a particular configuration item type and set of attributes. Then, IRE 514 might only permit this authoritative data source to write to the particular configuration item, and writes from unauthorized data sources may be prevented. Thus, the authorized data source becomes the single source of truth regarding the particular configuration item. In some cases, an unauthorized data source may be allowed to write to a configuration item if it is creating the configuration item or the attributes to which it is writing are empty.

Additionally, multiple data sources may be authoritative for the same configuration item or attributes thereof. To avoid ambiguities, these data sources may be assigned precedences that are taken into account during the writing of configuration items. For example, a secondary authorized data source may be able to write to a configuration item's attribute until a primary authorized data source writes to this attribute. Afterward, further writes to the attribute by the secondary authorized data source may be prevented.

In some cases, duplicate configuration items may be automatically detected by IRE 514 or in another fashion. These configuration items may be deleted or flagged for manual de-duplication.

### VII. LARGE LANGUAGE MODELS

A large language model (LLM) is an advanced computational model, primarily functioning within the domain of natural language processing (NLP) and machine learning. An LLM can be configured to understand, interpret, generate, and respond to human language in a manner that is both contextually relevant and syntactically coherent. The underlying structure of an LLM is typically based on a neural network architecture, more specifically, a variant of the transformer model. Transformers are notable for their ability to process sequential data, such as text, with high efficiency.

The operation of an LLM involves layers of interconnected processing units, known as neurons, which collectively form a deep neural network. This network can be trained on vast datasets comprising text from diverse sources, thereby enabling the LLM to learn a wide array of language patterns, structures, and colloquial nuances for prose, poetry, and program code. The training process involves adjusting the weights of the connections between neurons using algorithms such as backpropagation, in conjunction with optimization techniques like stochastic gradient descent, to minimize the difference between the LLM's output and expected output.

An aspect of an LLM's functionality is its use of attention mechanisms, particularly self-attention, within the transformer architecture. These mechanisms allow the model to weigh the importance of different parts of the input text differently, enabling it to focus on relevant aspects of the data when generating responses or analyzing language. The self-attention mechanism facilitates the model's ability to generate contextually relevant and coherent text by understanding the relationships and dependencies between words or tokens in a sentence (or longer parts of texts), regardless of their position.

Upon receiving an input, such as a text query or a prompt, the LLM may process this input through its multiple layers, generating a probabilistic model of the language therein. It predicts the likelihood of each word or token that might follow the given input, based on the patterns it has learned during its training. The model then generates an output, which could be a continuation of the input text, an answer to a query, or other relevant textual content, by selecting words or tokens that have the highest probability of being contextually appropriate.

Furthermore, an LLM can be fine-tuned after its initial training for specific applications or tasks. This fine-tuning process involves additional training (e.g., with reinforcement from humans), usually on a smaller, task-specific dataset, which allows the model to adapt its responses to suit particular use cases more accurately. This adaptability makes LLMs highly versatile and applicable in various domains, including but not limited to, chatbot development, content creation, language translation, and sentiment analysis.

Some LLMs are multimodal in that they can receive prompts in formats other than text and can produce outputs in formats other than text. Thus, while LLMs are predominantly designed for understanding and generating textual data, multimodal LLMs extend this functionality to include multiple data modalities, such as visual and auditory inputs, in addition to text.

A multimodal LLM can employ an advanced neural network architecture, often a variant of the transformer model that is specifically adapted to process and fuse data from different sources. This architecture integrates specialized mechanisms, such as convolutional neural networks for visual data and recurrent neural networks for audio processing, allowing the model to effectively process each modality before synthesizing a unified output.

The training of a multimodal LLM involves multimodal datasets, enabling the model to learn not only language patterns but also the correlations and interactions between different types of data. This cross-modal training results in multimodal LLMs being adept at tasks that require an understanding of complex relationships across multiple data forms, a capability that text-only LLMs do not possess. This makes multimodal LLMs particularly suited for advanced applications that necessitate a holistic understanding of multimodal information, such as chatbots that can interpret and produce images and/or audio.

### VIII. CAUSAL DISCOVERY

A goal of causal discovery is to determine the possible and likely causes of process inefficiencies. Such inefficiencies typically involve the process taking too long to complete (e.g., spending too much time in certain states) or completing in an incorrect fashion. Such an issue might have proximate causes that directly contribute to the observed inefficiencies, as well as distal causes that indirectly contribute to the observed inefficiencies (e.g., the distal causes might contribute directly or indirectly to the proximate causes). Generally speaking, distal causes originate earlier in time than proximate causes.

Each of the process inefficiencies, the proximate causes, and the distal causes may be respectively represented by one or more variables. Once the proximate and distal causes of a process inefficiency are discovered, recommendations can be made with regard to mitigating the inefficiency.

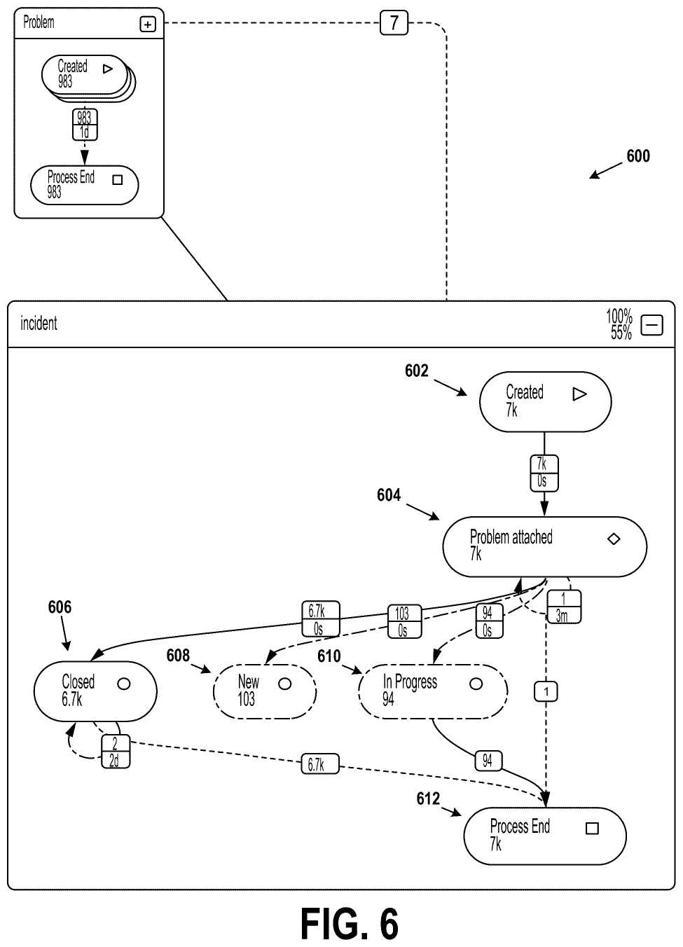

FIG. 6 depicts an example process 600. Process 600 depicts the states and flow volume of work items through a process. In this figure, the work items are IT incidents and the process is related to analysis and resolution of these incidents, but this domain is for purposes of example and other processes (e.g., problems, requests, and/or cases) could be analyzed in the fashion described herein.

Notably, process 600 as shown has six states (created 602, problem attached 604, closed 606, new 608, in progress 610, and process end 612) as well as various transitions between these states in the form of edges. Numbers on each edge indicate the volume of incidents that exhibit a transition between the states that the edge connects. While this representation of the flow volume between the states of process 600 provides some insights into the operation of the process, it does not easily translate into actions that can be used to improve the process. For example, if the time to resolution (TTR) or mean time to resolution (MTTR) of incidents is higher than expected or higher than industry standard, can be difficult if not impossible to determine why this is the case just from the information in FIG. 6.

For instance, proximate causes of a high TTR could be any one or more of too many incidents being marked as closed 606 then returned to the in progress state 610, manual or peer review approvals of resolutions taking too long, too many escalations to level 2 or level 3 incident resolution teams (where level 1 teams are the first ones involved, then level 2 teams and level 3 teams are brought in as needed), a large amount of time spent waiting in the new state 608, few opportunities for user self-service, and/or high rates of incident re-categorization, just to name a few. Distal causes might be the type of incident, the type of hardware involved in the incident, and incident channel (e.g., phone, service desk, web portal, or email). But the process administrator might only observe the high TTR. The cause(s) of the high TTR are not directly observable because they are buried in the process data.

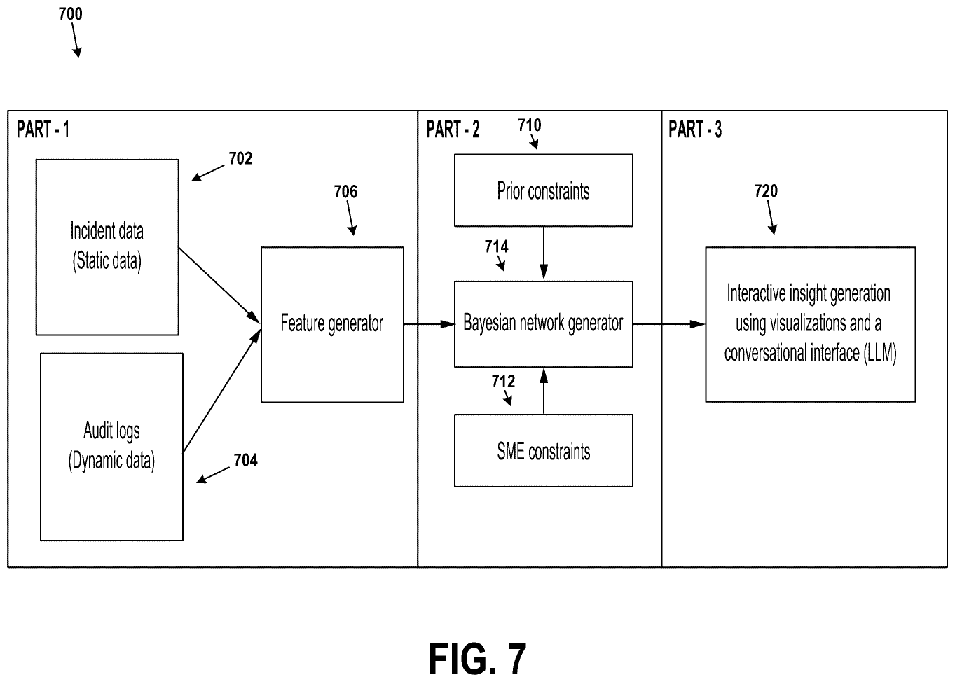

To overcome these limitations and drawbacks, the embodiments herein can employ a three-part procedure 700 as illustrated in FIG. 7. The first part involves gathering static incident data 702 from open incidents and dynamic log data 704 from logs of how incidents proceed through the process (e.g., time spent in states, transitions between states, etc.). From this static and dynamic data, features can be generated by feature generator 706, where these features characterize the observed operation of the process.

The second part involves applying structure learning to develop a directed acyclic graph of conditional probabilities of causalities between these features (e.g., a Bayesian network). Prior constraints 710 and other constraints 712 provided by subject matter experts can be used to add or remove edges from this graph by Bayesian network generator 714.

The third part involves generating insights and recommendations from the graph and the conditional probabilities at block 720. Such insights can be obtained by constructing an inference table that captures the distribution of outcome variables for a set of input variables. Further, an LLM may be prompted with the results of the analysis (e.g., the causal graph and/or conditional probabilities, as well as potentially any kind of quantity derived from combinations of the causal graph and conditional probabilities, such as interventional distributions estimated by do-calculus) to enable a conversational interface for querying the results and generating actionable insights.

Each of these parts will be discussed in more detail below. Nonetheless, other parts may be involved and not all given parts need to be carried out in some situations.

### A. Feature Generation

As noted, feature generation may be based on static data 702 and dynamic data 704. Here, static data 702 is generally regarded as incident data that does not change throughout the process, such as the incident number, the time that the incident was created, the user who opened the incident, and so on. Dynamic data 704 is expected to change over time, and may include the state of the incident, the agent or group assigned to resolve the incident, and so on. Also, the feature data may include variables that can be derived from the static and dynamic feature data that can, in turn, provide important insights into the operation of a process.

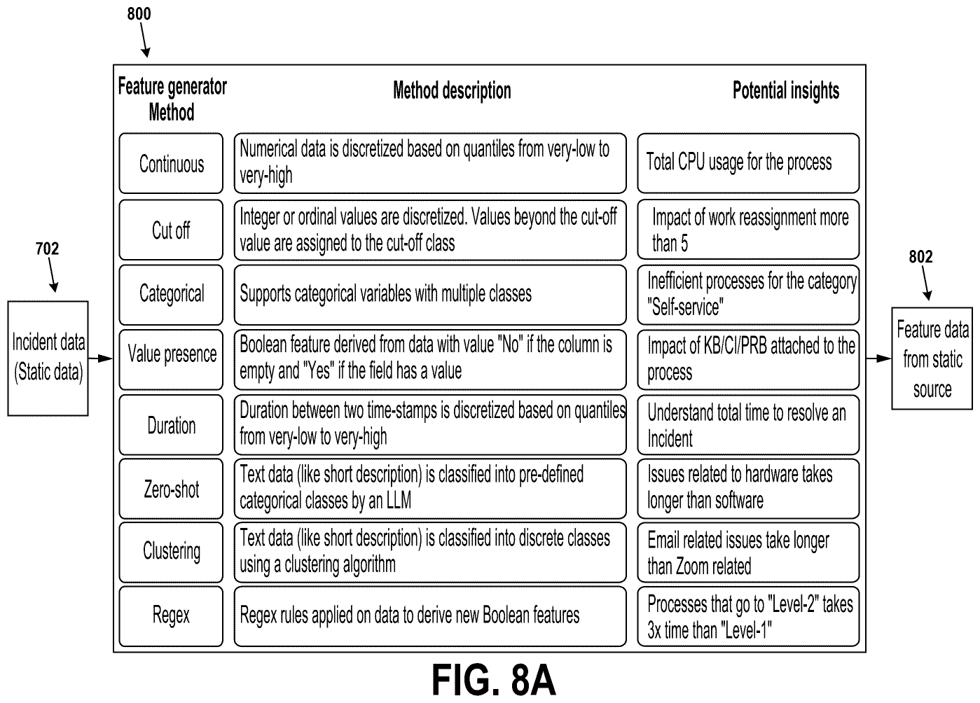

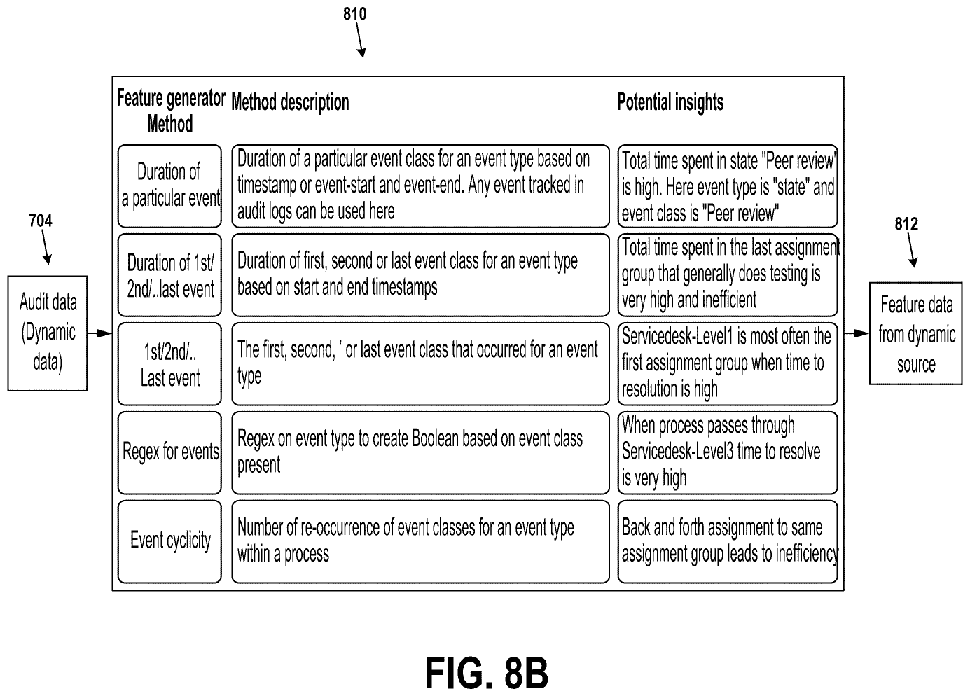

FIG. 8A depicts methods for feature generation based on static data 702. Each method 800 is a way of processing the information in one or more fields of an incident to gain further insight therefrom and to generate feature data 802. The following methods may be supported.

Continuous: Continuous data is discretized based on quantiles (e.g., very low, low, medium, high, or very high) or standard deviations. Useful for representing processor or memory utilization, for example.

Cut off: Integer or ordinal values are discretized and values beyond a threshold are cut off and assigned to the cut off class. Useful for representing the impact of rare events and/or variables with long-tailed distributions.

Categorical: Variables can take on values from two or more categories. Useful for representing categorical data.

Value Presence: A Boolean value that is true if the field has a value and false otherwise. Useful for representing whether certain information is present.

Duration: The time duration (e.g., in seconds) between two time stamps. This may be discretized based on quantiles similar to that of the continuous method.

Zero-Shot: Textual data is classified into predefined categories by an LLM. Useful for mapping free-form text fields (e.g., short or long descriptions) to categories when the desired categories are known ahead of time.

Clustering: Textual data is classified into discrete categories using a clustering technique. Useful for mapping free-form text fields (e.g., short or long descriptions) to categories when the categories are not known ahead of time or desired to be granular.

Regex: Applying a regular expression to filter values of a field and thereby derive a new Boolean feature. Useful for detecting the presence of patterns in fields.

FIG. 8B depicts methods for feature generation based on dynamic data 704. Each method 810 is a way of processing the information in one or more incident logs to gain further insight therefrom and generate feature data 812. The following methods may be supported.

Duration of event: The duration of an event, event class, or event type based on timestamps in event logs. Useful for determining the states in which an incident spends the most time.

Duration of 1st, 2nd, . . . , last event: The duration of the nth instance of an event (e.g., the first instance, second instance, last instance) in a particular state based on timestamp in event logs. Useful for determining with greater detail where inefficiencies lie (e.g., with the first group to which an incident is assigned).

1st, 2nd, . . . , last event: The nth instance of an event (e.g., the first instance, second instance, last instance) that occurred based on timestamp in event logs. Useful for determining with greater detail where inefficiencies lie (e.g., with the first group to which an incident is assigned).

Regex for events: Applying a regular expression to filter values of an event and thereby derive a new Boolean feature. Useful for detecting the presence of patterns in events.

Event cycles: The number of reoccurrences of an event for a work item. Useful for determining where work items tend to ping-pong or loop in the process, which leads to inefficiencies.

The feature data derived from static (work item related) and dynamic (event related) data may be used to determine insights into the inefficiencies of a process. Nonetheless, feature data other than that which is shown in FIGS. 8A and 8B may be derived and used.

### B. Structure Learning

As noted, structure learning (e.g., using Bayesian network generator 714) can be used to develop a directed acyclic graph (DAG) of conditional probabilities representing causalities between the features in the feature data. Each unit of the feature data generated from the static data 702 and dynamic data 704 is categorized as either coarse-grained or fine-grained based on its temporal origins. Doing so imposes temporal constraints on how of the DAG can be constructed.

For example, the attachment of information (e.g., a knowledgebase article or application output) to an incident is considered fine-grained because it occurs during processing of the incident. On the other hand, the channel of the incident is coarse-grained because it is known when the incident is created. Note that coarse-grained data can either be static or dynamic. Fine-grained data is generally dynamic but need not be.

This division of variables into coarse-grained and fine-grained allows temporal and causal relationships between these variables to be established. For example, a fine-grained variable cannot have a causal effect on a coarse-grained variable because the coarse-grained variable was present when the incident was created but the fine-grained variable was not. Thus, the edges in the graph can be pruned accordingly. Further, subject matter experts can establish additional causal rules that permit or prevent certain edges from being present.

The graph may be generated by an unsupervised structure learning technique such as Bayesian network generator 714. Examples of such techniques include score-based techniques that use a score function to evaluate the quality of a Bayesian network structure. They can search over the space of all possible Bayesian network structures to find the one with the highest score. For example, a maximum likelihood score function selects a Bayesian network structure that maximizes the posterior probability of the structure given the underlying data. Other techniques are constraint-based, in that they use conditional independence tests to infer the structure of a Bayesian network. They start with a complete graph, and then iteratively remove edges that are not supported by the data. Hybrid techniques combine the features of score-based and constraint-based techniques. They typically start with a complete graph and then use a score function to prune the graph, with penalties given to more complex structures.

Other techniques that may be used with score-based techniques or in a standalone fashion include hill-climbing and PC techniques. A hill climbing technique is a local search technique that starts with an initial solution and iteratively makes small improvements to it, in order to optimize some objective function (e.g., maximizing the posterior probability of the structure given the underlying data). A PC technique is a constraint-based technique for causal discovery. It starts with a complete undirected graph and iteratively removes edges that are not supported by the data. The technique is based on the principle of conditional independence, which states that two variables are independent if they are conditionally independent given a set of other variables.

Ultimately, the graph can be a causal Bayesian network (causal graph and conditional probabilities related to node-by-node traversals of the causal graph). The causal graph indicates dependencies and the conditional probabilities provide the parameters of the distribution of each variable given its causes.

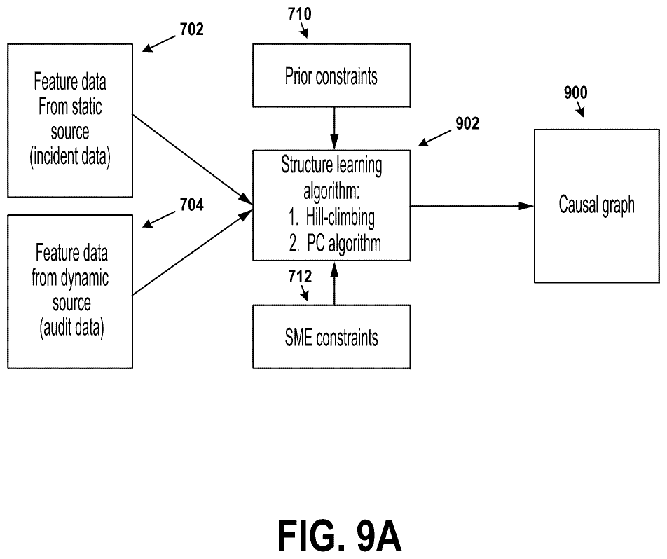

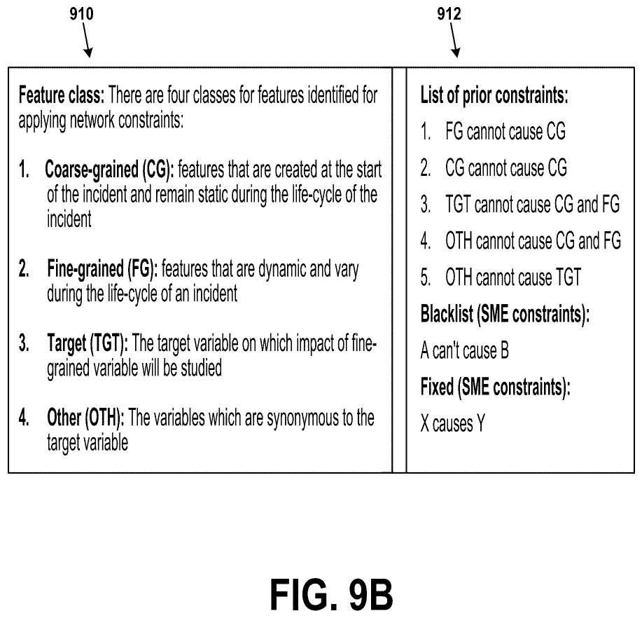

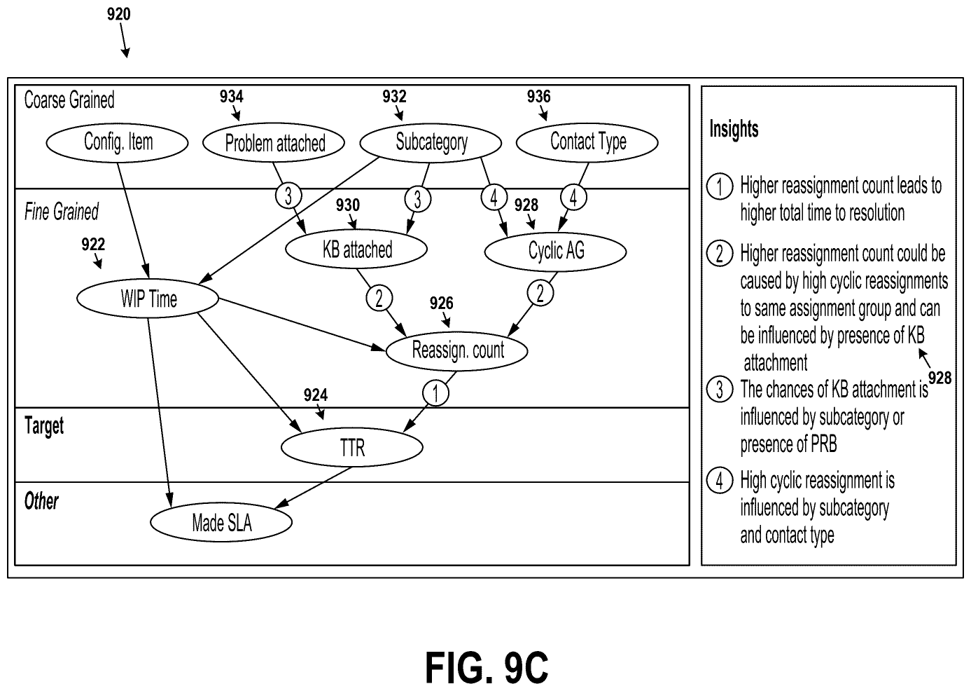

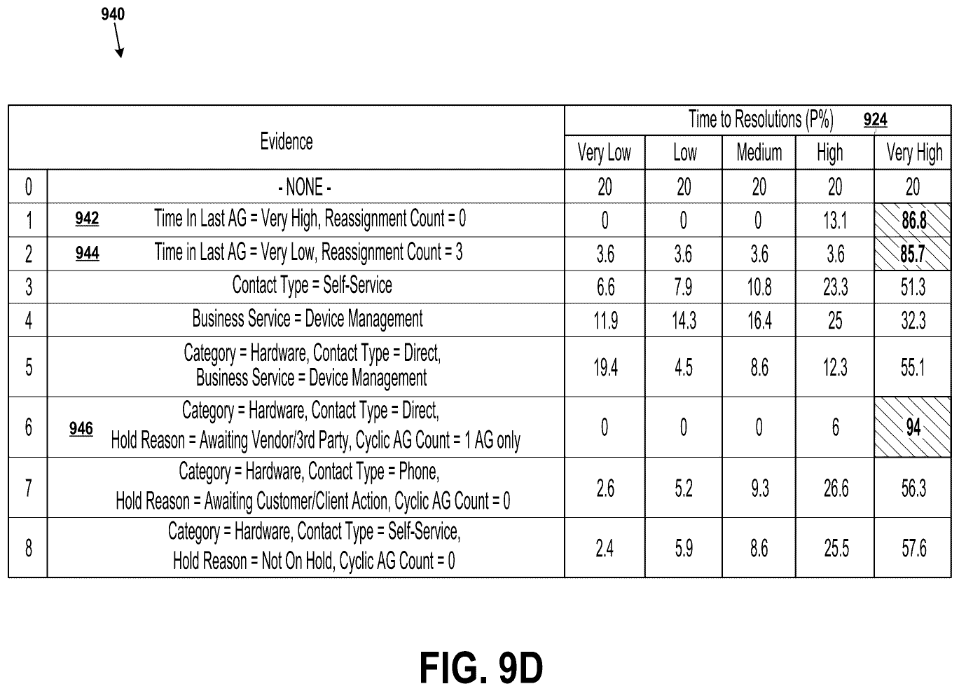

FIG. 9A depicts the structure learning process. A structure learning algorithm 902 (e.g., hill-climbing, PC, or another type) uses static feature data 702 from static sources (e.g., work items in an incident database) and dynamic feature data 704 from dynamic sources (event logs), prior causal constraints 710, and/or subject matter expert constraints 712 to generate a causal graph 900. Then, conditional probabilities are assigned to the edges of causal graph 900 (e.g., given a child node and possibly its class or type, the conditional probabilities of each parent node being a cause of the child node).

FIG. 9B depicts constraints on structured learning. Each feature is placed in one of four classes 910:

Coarse-grained (CG): Defined during incident creation and unlikely to change during the life cycle of the incident.

Fine-grained (FG): Defined after incident creation and may vary throughout the life cycle of the incident.

Target (TGT): The variable on which the impact of FG variables will be analyzed (e.g., TTR).

Other (OTH): Variables that are synonymous to, similar to, or derived from the TGT variable (e.g., total time to close an incident when TTR is the TGT variable).

FIG. 9B also includes rules 912 that define prior constraints. These are that: an FG variable cannot cause a CG variable, a CG variable cannot cause another CG variable, a TGT variable cannot cause either an FG or CG variable, and an OTH variable cannot cause an FG, CG, or TGT variable. Additionally, SME constraints may be applied, where these constraints indicate that a variable A cannot cause another variable B or that a variable X always causes a variable Y

FIG. 9C provides an example of a generated causal graph 920. In causal graph 920, the TGT variable is TTR. An OTH variable is whether the TTR achieves an associated service-level agreement that, for example, specifies a maximum acceptable TTR. For purposes of illustration, FIG. 9C also provides some insights that can be derived from example feature data. Insight determination will be discussed in more detail below.

The causal graph 920 indicates that there is a causal relationship between time spent in the in progress state (WIP time 922) and TTR 924, as well as between the reassignment count 926 (the number of times the work item has been reassigned to a different agent) and TTR 924. In other words, WIP time 922 and reassignment count 926 both have a causal influence over TTR 924. In particular, as shown in insight 1, a higher reassignment count 926 is expected to result in a higher TTR 924.

In turn, such a higher reassignment count 926 can be caused by a high number of cyclic reassignments 928 to the same agent or group of agents, as well as the presence of knowledgebase articles 930 attached to incidents (insight 2). A knowledgebase article 930 being attached to an incident can be caused by a particular subcategory 932 of incident and by a problem 934 (another type of work item) being attached to the incident (insight 3). Also, cyclic reassignments 928 can be caused by the subcategory 932 and the contact type 936 of the incident (insight 4).

The example causal graph of FIG. 9C was generated from just prior constraints, and therefore does not reflect any SME constraints. In other situations, SME constraints may be included.

FIG. 9D depicts conditional probabilities of time to resolution for various combinations of feature values in table 940. This table is for purposes of example, and other tables can be generated. Notably, table 940 identifies scenarios 942, 944, and 946 in which TTR 924 tends to be very high (e.g., in more than 85% of all occurrences).

### C. Generating Insights and Recommendations

The conditional probabilities generated for the graph can be used to further generate process insights and recommendations. For instance, if an incident is of a particular type, the graph may provide a probability distribution for lengths of TTR (e.g., very low, low, medium, high, and very high). But, especially for large graphs, these conditional probabilities can be difficult to interpret accurately and translate into actionable insights and recommendations.

Thus, the embodiments herein may employ an LLM to provide these insights and recommendations. Particularly, an LLM may be prompted with the graph structure and/or its conditional probabilities, and asked to provide insights such as an executive summary or recommended actions.

As noted above, LLMs are machine-learning constructs that can be trained on vast amounts of textual data, such as books, articles, and websites, to learn patterns and relationships between words and phrases. Some examples of LLMs include GPT-4, bidirectional encoder representations from transformers (BERT), language model for dialogue applications (LaMDA), and Transformer-XL. LLMs can perform a wide range of natural language processing tasks, such as summarization, text classification, question answering, and language translation. These LLMs also have the ability to create coherent and human-like text. Many LLMs are based on the transformer architecture, which employs self-attention when considering different parts of an input sequence (e.g., of tokens such as words) to compute a representation of each element in the sequence taking long-range dependence between elements into account.

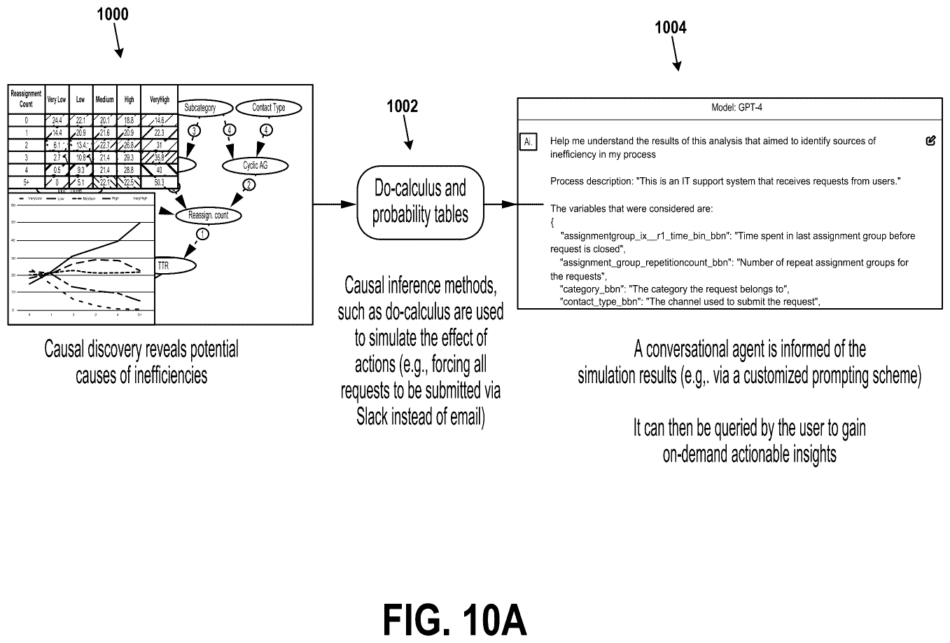

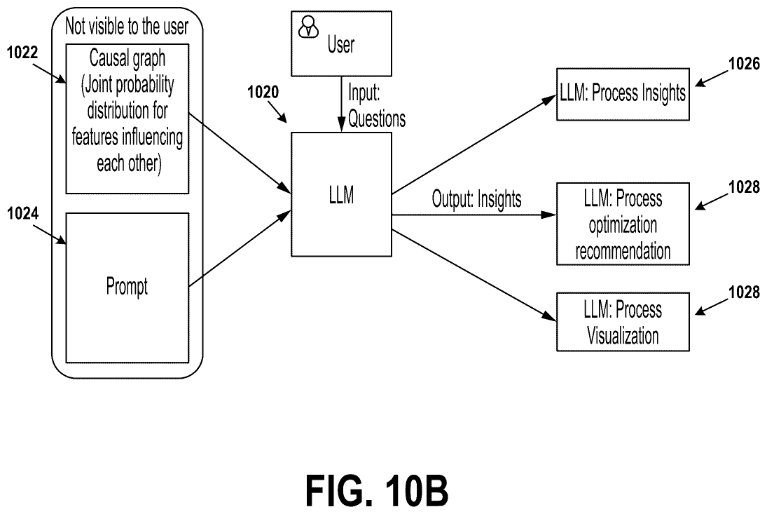

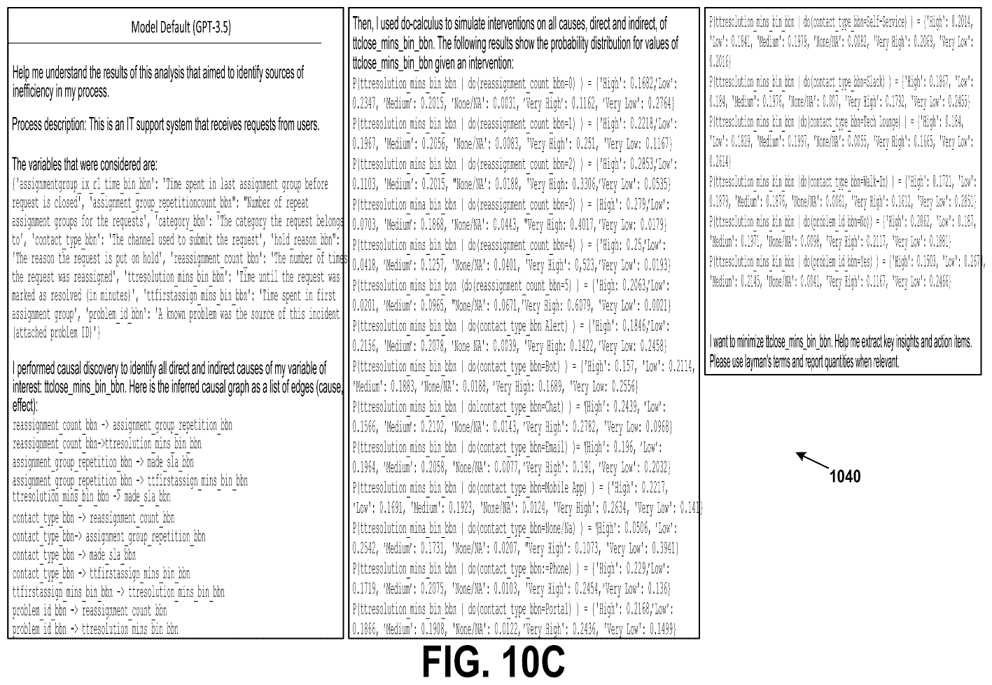

FIGS. 10A and 10B depict this process. In block 1000 of FIG. 10A, causal discovery is used, as described above, to reveal potential causes of inefficiencies. Then, in block 1002 causal inference methods, such as do-calculus, can be used to simulate the effects of various actions or changes made to the process. In block 1004, a conversational agent (e.g., an LLM) can use the simulation results to, via a customized prompting scheme, provide on-demand actionable insights.

Do-calculus is a framework for determining causal inferences in graphs. It allows modification of variables in such a model by setting them to a specific value, which is denoted by the “do” operator, written as “do(X=x)”. Do-calculus applies a pre-defined set of rules to go from a quantity that contains causal statements—e.g., P(Y|do(X=x))—to an equivalent quantity that does not contain “do” statements and that can be estimated from the data. For instance:

$$P ( Y \vert do ( X = x ) ) = {\sum }_{z} P ( Y \vert X = x , Z = z ) P ( Z = z )$$

This quantity can be estimated using the conditional probabilities obtained by the structure learning process. It is assumed that Z blocks all paths from X to Y in the causal graph.

FIG. 10B depicts this technique in more detail. An LLM 1020 receives a causal graph 1022 with conditional probabilities as well as other information and/or a request in a prompt 1024. The LLM 1020 may, in response, produce various process insights 1026, process optimization recommendations 1028, and/or process visualizations 1030. In some cases, the LLM 1020 may provide an interactive interface through which a user may prompt the LLM 1020 with further questions.

FIG. 10C depicts an example prompt 1040 (or series of prompts) provided to the LLM. The prompt includes: the goal of the result (identifying sources of inefficiency in a process), variables, the result of causal discovery on these variables, the result of performing do-calculus to generate the conditional probabilities, and insights and actions related to a specific goal (minimize ttclose_mins_bin_bbn).

### D. Summary

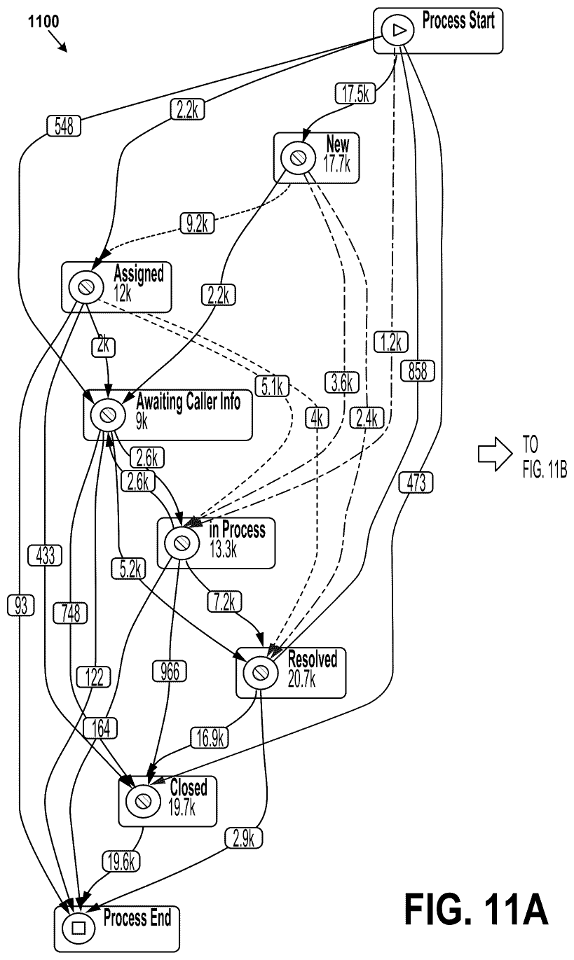

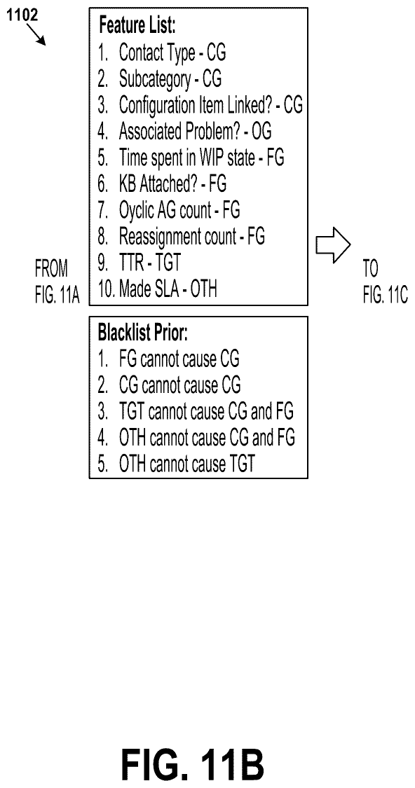

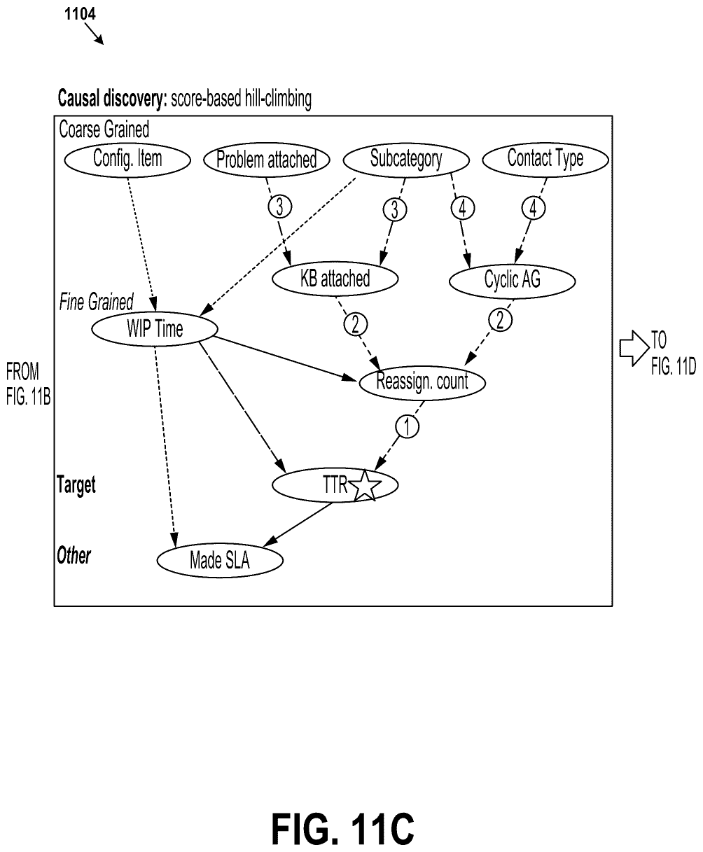

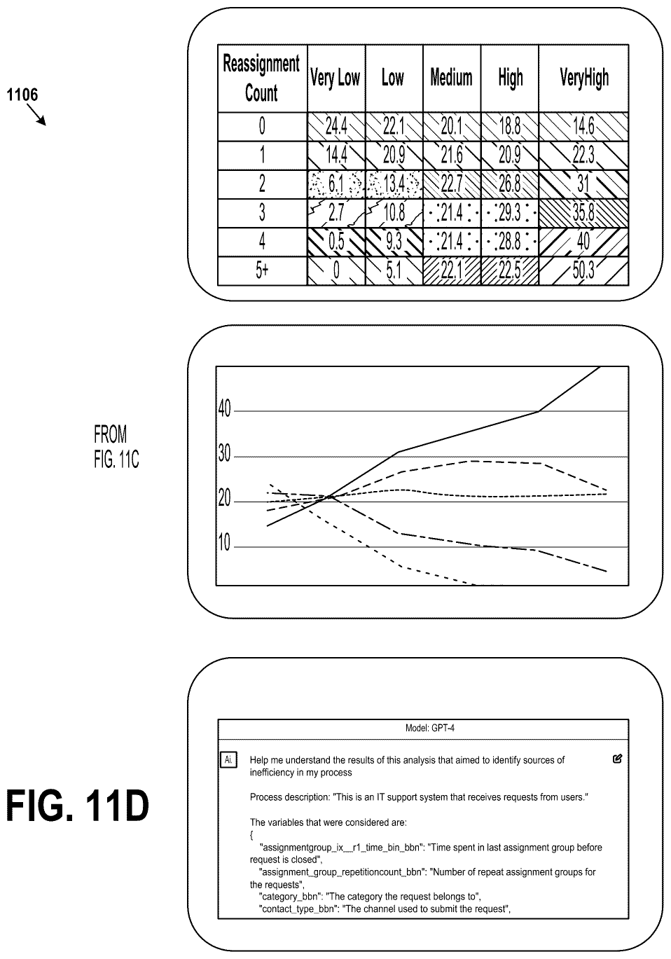

FIGS. 11A-11D summarize the aspect discussed above. Given work item and event data relating to a process 1100 (e.g., incident management as shown in FIG. 11A), features 1102 are extracted (FIG. 11i). Then, a subset of features 1102 that are causal drivers of a target variable of interest are identified. A structure learning technique is used to develop a causal graph 1104 with conditional probabilities (FIG. 11C). An LLM may be employed to generate insights 1106 from the causal graph 1104 (FIG. 11D).

### IX. EXAMPLE OPERATIONS

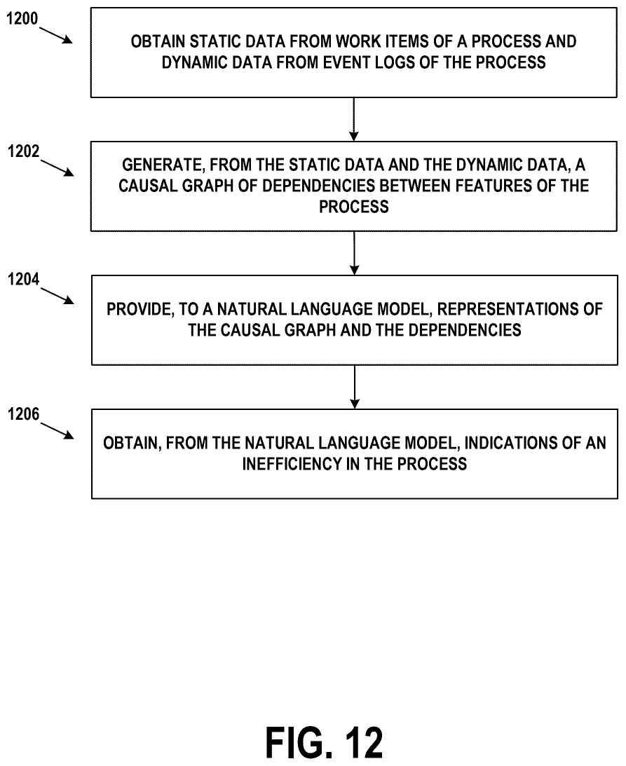

FIG. 12 is a flow chart illustrating an example embodiment. The process illustrated by FIG. 12 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 12 may be simplified by the removal of any one or more of the features shown therein. Further, these embodiments may be combined with features, aspects, and/or implementations of any of the previous figures or otherwise described herein.

Block 1200 may involve obtaining static data from work items of a process and dynamic data from event logs of the process.

Block 1202 may involve generating, from the static data and the dynamic data, a causal graph of dependencies between features of the process.

Block 1204 may involve providing, to a natural language model, representations of the causal graph and the dependencies.

Block 1206 may involve obtaining, from the natural language model, indications of an inefficiency in the process. In some cases, indications of multiple inefficiencies may be provided. Further, the model could provide a summary of the main source(s) of inefficiency and/or provide recommendations or insights into have to address the inefficiencies. Block 1206, alone or in combination with the other blocks of FIG. 12, provide a technical solution to a technical problem. A technical problem being solved is that of determining root cause of an inefficiency or issue in a managed network. Improper or delayed root cause identification results in more system degradation and longer periods of downtime. The embodiments herein provide improved techniques for identifying root causes of these inefficiencies and issues, resulting in the drawbacks of system degradation and downtime being mitigated.

In some embodiments, the process is an incident management workflow, wherein the work items are incidents, and wherein the event logs record changes to the incidents as they progress through the incident management workflow.

In some embodiments, the features are represented as nodes in the causal graph.

Some embodiments may involve generating the features from the static data and the dynamic data.

In some embodiments, the features include representations of: time that the work items spend in various states of the process, classes or categories of the work items, whether particular types of database entries are attached to the work items, or cycles exhibited by the work items as they progress through the process.

In some embodiments, generating the causal graph comprises: classifying at least some of the features as either coarse-grained because their values were known when an associated work item was created, fine-grained because their values became known during performance of the process on the associated work item, or target because their values are observable outcomes of the process.

In some embodiments, generating the causal graph further comprises applying prior constraints to structure of the causal graph, wherein the prior constraints include: fine-grained features not causing coarse-grained features, the coarse-grained features not causing other coarse-grained features, and target features not causing either the fine-grained features or the coarse-grained features.

In some embodiments, generating the causal graph comprises applying expert-derived constraints to structure of the causal graph.

In some embodiments, the dependencies are conditional probabilities.

Some embodiments further involve performing a causal inference technique on the causal graph to simulate effects of making changes to the process. In some embodiments, the causal inference technique comprises do-calculus.

In some embodiments, the natural language model is a large language model.

In some embodiments, the inefficiency in the process is an outcome of the process taking more than a threshold amount of time to achieve, time spent in a state of the process being more than a further threshold amount of time, or the work items cycling between states of the process.

Some embodiments further involve, in response to receiving the indications of the inefficiency in the process, automatically changing a structure of the process or automatically modifying the type or amount of hardware or software that performs the process.

### X. CLOSING

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid-state drive, or another storage medium.

The computer readable medium can also include non-transitory computer readable media such as non-transitory computer readable media that store data for short periods of time like register memory and processor cache. The non-transitory computer readable media can further include non-transitory computer readable media that store program code and/or data for longer periods of time. Thus, the non-transitory computer readable media may include secondary or persistent long-term storage, like ROM, optical or magnetic disks, solid-state drives, or compact disc read only memory (CD-ROM), for example. The non-transitory computer readable media can also be any other volatile or non-volatile storage systems. A non-transitory computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A method comprising:
obtaining static data from work items of a process and dynamic data from event logs of the process;
generating, from the static data and the dynamic data, a causal graph of dependencies between features of the process;
providing, to a natural language model, representations of the causal graph and the dependencies; and
obtaining, from the natural language model, indications of an inefficiency in the process.

2. The method of claim 1, wherein the process is an incident management workflow, wherein the work items are incidents, and wherein the event logs record changes to the incidents as they progress through the incident management workflow.

3. The method of claim 1, wherein the features are represented as nodes in the causal graph.

4. The method of claim 1, further comprising:
generating the features from the static data and the dynamic data.

5. The method of claim 1, wherein the features include representations of: time that the work items spend in various states of the process, classes or categories of the work items, whether particular types of database entries are attached to the work items, or cycles exhibited by the work items as they progress through the process.

6. The method of claim 1, wherein generating the causal graph comprises:
classifying at least some of the features as either coarse-grained because their values were known when an associated work item was created, fine-grained because their values became known during performance of the process on the associated work item, or target because their values are observable outcomes of the process.

7. The method of claim 6, wherein generating the causal graph further comprises:
applying prior constraints to structure of the causal graph, wherein the prior constraints include: fine-grained features not causing coarse-grained features, the coarse-grained features not causing other coarse-grained features, and target features not causing either the fine-grained features or the coarse-grained features.

8. The method of claim 1, wherein generating the causal graph comprises:
applying expert-derived constraints to structure of the causal graph.

9. The method of claim 1, wherein the dependencies are conditional probabilities.

10. The method of claim 1, further comprising:
performing a causal inference technique on the causal graph to simulate effects of making changes to the process.

11. The method of claim 10, wherein the causal inference technique comprises do-calculus.

12. The method of claim 1, wherein the natural language model is a large language model.

13. The method of claim 1, wherein the inefficiency in the process is an outcome of the process taking more than a threshold amount of time to achieve, time spent in a state of the process being more than a further threshold amount of time, or the work items cycling between states of the process.

14. The method of claim 1, further comprising:
in response to receiving the indications of the inefficiency in the process, automatically changing a structure of the process or automatically modifying a type or amount of hardware or software that performs the process.

15. A non-transitory computer-readable medium, having stored thereon program instructions that, upon execution by a computing system, cause the computing system to perform operations comprising
obtaining static data from work items of a process and dynamic data from event logs of the process;
generating, from the static data and the dynamic data, a causal graph of dependencies between features of the process;
providing, to a natural language model, representations of the causal graph and the dependencies; and
obtaining, from the natural language model, indications of an inefficiency in the process.

16. The non-transitory computer-readable medium of claim 15, wherein generating the causal graph comprises:
classifying at least some of the features as either coarse-grained because their values were known when an associated work item was created, fine-grained because their values became known during performance of the process on the associated work item, or target because their values are observable outcomes of the process.

17. The non-transitory computer-readable medium of claim 16, wherein generating the causal graph further comprises:
applying prior constraints to structure of the causal graph, wherein the prior constraints include: fine-grained features not causing coarse-grained features, the coarse-grained features not causing other coarse-grained features, and target features not causing either the fine-grained features or the coarse-grained features.

18. The non-transitory computer-readable medium of claim 15, wherein the inefficiency in the process is an outcome of the process taking more than a threshold amount of time to achieve, time spent in a state of the process being more than a further threshold amount of time, or the work items cycling between states of the process.

19. The non-transitory computer-readable medium of claim 15, the operations further comprising:
in response to receiving the indications of the inefficiency in the process, automatically changing a structure of the process or automatically modifying a type or amount of hardware or software that performs the process.

20. A system comprising:
one or more processors; and
memory, containing program instructions that, upon execution by the one or more processors, cause the system to perform operations comprising:
obtaining static data from work items of a process and dynamic data from event logs of the process;
generating, from the static data and the dynamic data, a causal graph of dependencies between features of the process;
providing, to a natural language model, representations of the causal graph and the dependencies; and
obtaining, from the natural language model, indications of an inefficiency in the process.
